(19) United States
(12) Patent Application Publication
(10) Pub. No.: US 2008/0019739 A1
(43) Pub. Date: Jan. 24, 2008

(54) Image forming apparatus and image forming method

(75) Inventor: Tooru Oouchi, Tokyo (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/819,731

(22) Filed: Jun. 28, 2007

(30) Foreign Application Priority Data
Jul. 24, 2006 (JP) 2006-200641

(51) Int. Cl. G03G 15/01

(52) U.S. Cl. 399/301

(57) ABSTRACT

Disclosed is an image forming apparatus including: a setting section to set an operation mode; a conveying section to successively convey recording media at an interval based on the set operation mode; an image forming section to form color images by forming toner images in which color toners are adhered on an intermediate transfer belt and transferring the toner images onto the conveyed recording media respectively; a memory section to store image data of an image adjustment pattern image used in an adjustment of the color image; and a control section to perform the image adjustment in a successive printing in which the images are successively formed, the image adjustment performed by forming an image adjustment toner image based on the image data in a region between the toner images of the successive printing formed on the intermediate transfer belt according to the set operation mode.

### CROSS-REFERENCE TO RELATED APPLICATIONS

The present U.S. Patent Application claims priority under the Paris Convention of Japanese Patent Application No. 2006-200641 filed on Jul. 24, 2006 to the Japanese Patent Office, which shall be a basis for correcting mistranslations.

### BACKGROUND

1. Field of the Invention

The present invention relates to an image forming apparatus and an image forming method.

2. Description of Related Art

In recent years, there are image forming apparatuses such as printers, etc. where image is formed on recording medium by forming electrostatic latent image on an intermediate transfer belt, adhering toner on the electrostatic latent image and transferring the image on the recording medium. There is a demand for such image forming apparatuses to form images on recording media more quickly and more beautifully.

In order to perform an image forming with beautiful colors in an image forming apparatus, it is necessary to perform an image adjustment such as adjusting printing position of colors, amount of application of ink, etc. A typical image adjustment is performed when power is turned on, when a certain amount of sheets are printed (for example every 100 pages of printing), when a predetermined span of time passes, when an environment of an apparatus changes, or when a consumable item such as a toner cartridge, a print unit, etc. is replaced.

Such image adjustment is performed in an above described timing in order to control change of solid color density caused by change of charged toner amount due to variation of photo receptor sensitivity, image development and light exposure amount, environment and durability. The image adjustment is also performed in order to correct to a certain level variations of thin line reproducibility and white patch reproducibility caused by variations (individual difference, environment, and durability) of photoreceptor electrostatic characteristics (charging characteristics and light exposure sensitivity characteristics), image development characteristics (efficiency and edge enhancement), and transfer characteristics (accuracy and efficiency). The image adjustment is also performed in order to obtain tone characteristics necessary for image processing in image forming, and in order to correct color shift caused by scatterings and variations of drawing positions of colors.

In performing such image adjustment, for example, if the apparatus is in execution of a successive printing on recording media, a printing job presently in process is temporarily paused to perform the image adjustment, and after the image adjustment ends, the printing is resumed. Thus, when the image adjustment is performed during the successive printing, it takes longer time before image forming is performed on all of the recording media, causing a decrease in average printing speed. Especially when image forming is performed on large amounts of recording media, the image adjustment may be performed a plurality of times, and time consumed for the image adjustment cannot be disregarded.

As a method of shortening time consumed for such image adjustment, image adjustment processing with an apparatus provided with more image adjustment sensors than a conventional apparatus is considered. For example, Japanese Patent Application Laid-Open Publication No. 2005-31404 discloses a technique in which by employing four sensors in an apparatus for image adjustment to perform image adjustment processing of four colors simultaneously, processing time consumed for the image adjustment can be shortened to the processing time for one color.

However, with a technique as above, many sensors for the image adjustment need to be provided in the apparatus, inviting an increase in cost. Thus, there is a concern that price competitiveness will be lost in distribution of such an image forming apparatus. In a case of successive image forming on recording media such as cardboard, etc., in which a large amount of heat is lost in toner fusing, time for heating is necessary. However, the time necessary for the heating has not been effectively used for image adjustment.

### SUMMARY

The present invention has been made in consideration of the above problems, and it is one of main objects to provide a technique for adjusting an image when a successive printing of color images on recording media such as cardboard, etc. is performed without increasing production cost of an apparatus or reducing printing speed.

An image forming apparatus reflecting one aspect of the present invention comprises: a setting section to set an operation mode in image forming; a conveying section to successively convey recording media for the image forming at an interval based on the set operation mode; an image forming section to form color images by forming toner images in which color toners are adhered on an intermediate transfer belt and transferring the toner images onto the conveyed recording media respectively; a memory section to store image data of an image adjustment pattern image used in an adjustment of the color image formed in the image forming section; and a control section to perform the image adjustment in a successive printing in which the images are successively formed on the recording media in the image forming section, the image adjustment performed by forming an image adjustment toner image based on the image data stored in the memory section in a region between the toner images of the successive printing formed on the intermediate transfer belt according to the set operation mode.

It is desirable that in the above described image forming apparatus, when the image adjustment of the successive printing is performed by forming a plurality of the image adjustment toner images, the control section allows the image forming section to successively form the image adjustment toner images in a plurality of regions between the toner images in the successive printing.

It is desirable that in the above described image forming apparatus, when the successive printing ends while the image adjustment of the successive printing is performed by forming the plurality of the image adjustment toner images, the control section allows the image forming section to form a remaining image of the plurality of the image adjustment toner images, which has not formed in the regions between the toner images.

It is desirable that in the above described image forming apparatus, the image data of the image adjustment pattern image stored in the memory section is image data of an adhesion amount adjustment pattern image to adjust toner amount adhered on the recording media, and the control section controls an adjustment of the toner amount adhered on the recording media in the image forming section by forming a toner amount adjustment toner image based on the image data in the region between the toner images.

It is desirable that in the above described image forming apparatus, the image data of the image adjustment pattern image stored in the memory section is image data of light amount adjustment pattern image to adjust light amount for forming the images on the recording media, and the control section controls an adjustment of the light amount for forming the images by the image forming section by forming a light amount adjustment toner image based on the image data in the region between the toner images.

It is desirable that in the above described image forming apparatus, the image data of the image adjustment pattern image stored in the memory section is image data of gamma value adjustment pattern image to adjust gamma value of the images formed on the recording media, and the control section controls an adjustment of the gamma value of the image formed by the image forming section by forming a gamma value adjustment toner images based on the image data in the region between the toner images.

It is desirable that in the above described image forming apparatus, the image data of the image adjustment pattern image stored in the memory section is image data of registration pattern image to adjust color shift of colors of the images formed on the recording media, and the control section controls a degree of the color shift of the colors of the images formed by the image forming section by forming a toner adhesion location adjustment toner image of the colors based on the image data in the region between the toner images.

It is desirable that in the above described image forming apparatus, the image data of the image adjustment pattern image stored in the memory section is image data of an integrated adjustment pattern image to adjust a color shift degree of the colors, a toner adhesion amount, a light amount, and a gamma value of the images formed on the recording media, and the control section controls an adjustment of the images formed on the recording media by the image forming section by forming an image adjustment toner image based on the image data in the region between the toner images.

It is desirable that in the above described image forming apparatus, the setting section sets the operation mode by receiving an operating instruction from a user.

It is desirable that in the above described image forming apparatus, the setting section sets the operation mode based on a type of the recording media conveyed by the conveying section.

### BRIEF DESCRIPTION OF THE DRAWINGS

These and other objects, advantages and features of the present invention will become more fully understood from the detailed description given hereinbelow and the appended drawings, and thus are not intended as a definition of the limits of the present invention, and wherein;

FIG. 1 is a block diagram schematically showing a functional configuration of an image forming apparatus;

FIG. 2 is a conceptual diagram schematically showing configurations of a conveying section, an image forming section, and a fusing section;

FIG. 3 is a conceptual diagram schematically showing contents of image forming instruction information;

FIG. 4A is a conceptual diagram schematically showing adhesion amount patterns formed on an intermediate transfer belt;

FIG. 4B is a conceptual diagram schematically showing light amount patterns formed on the intermediate transfer belt;

FIG. 4C is a conceptual diagram schematically showing gamma characteristics patterns formed on the intermediate transfer belt;

FIG. 4D is a conceptual diagram schematically showing registration patterns formed on the intermediate transfer belt;

FIG. 4E is a conceptual diagram schematically showing an integrated pattern formed on the intermediate transfer belt;

FIG. 5 is a flow chart showing an operation of the image forming apparatus;

FIG. 6 is a flow chart showing the operation of the image forming apparatus;

FIG. 7 is a conceptual diagram showing an example of regions between toner images on the intermediate transfer belt in a successive printing;

FIG. 8 is a conceptual diagram showing an example of forming image adjustment patterns in the regions between the toner images on the intermediate transfer belt in a successive printing; and

FIG. 9 is a conceptual diagram showing an example of forming pattern images on the intermediate transfer belt after a successive printing ends.

### DETAILED DESCRIPTION OF PREFERRED EMBODIMENTS

Embodiments of the present invention will be described in detail below with reference to the drawings, however the present invention is not limited to the embodiments described below. Also, the embodiment of the present invention shown is to show a best mode of the present invention and do not limit applications and terms of the present invention.

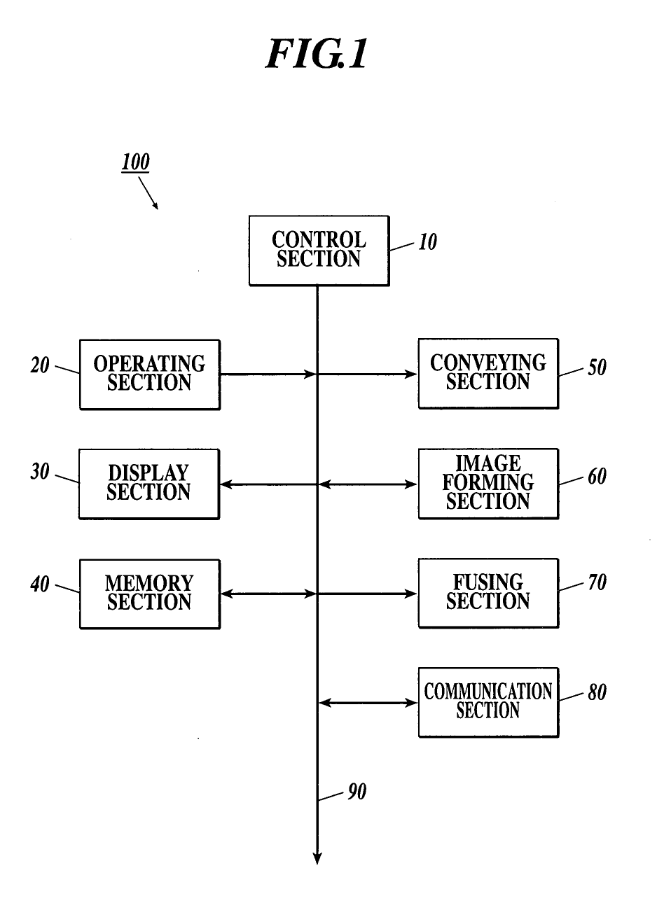

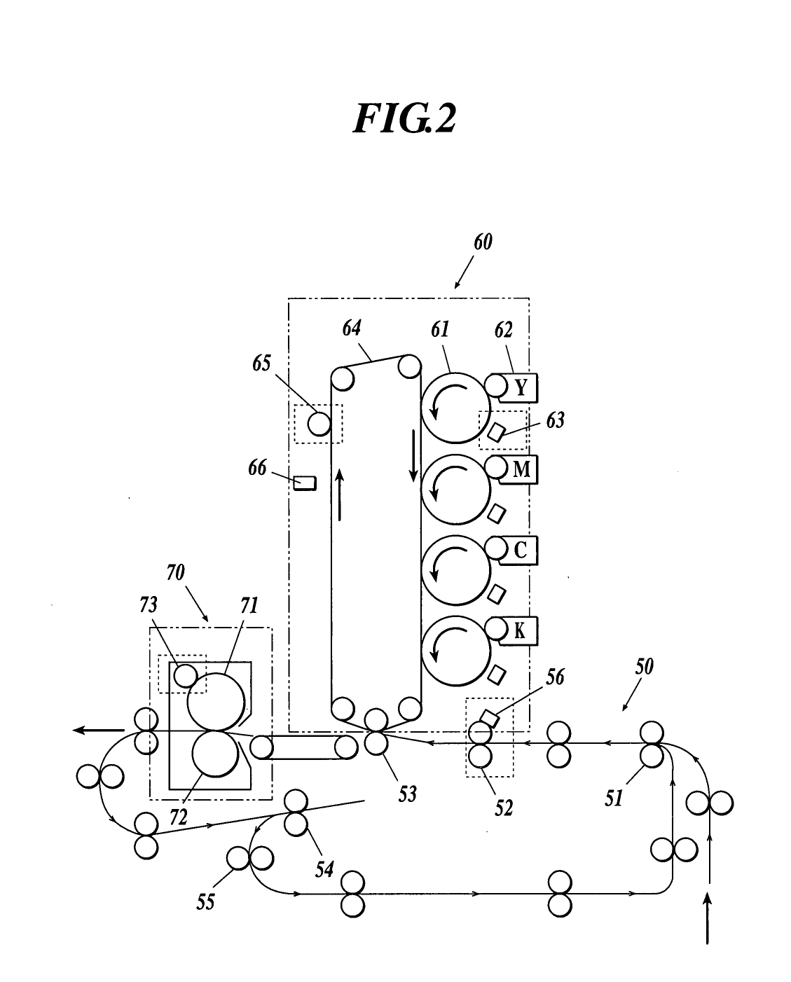

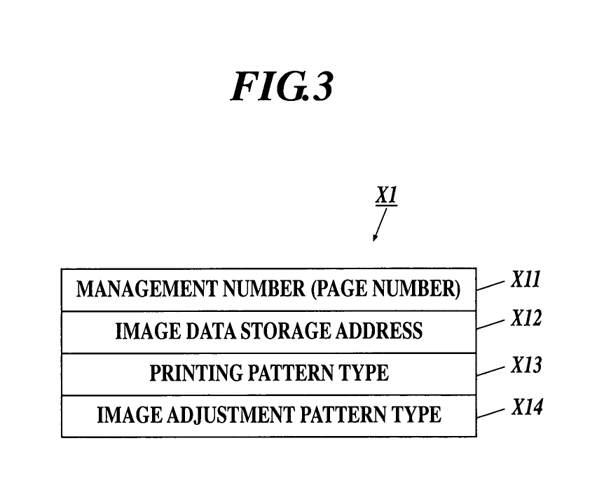

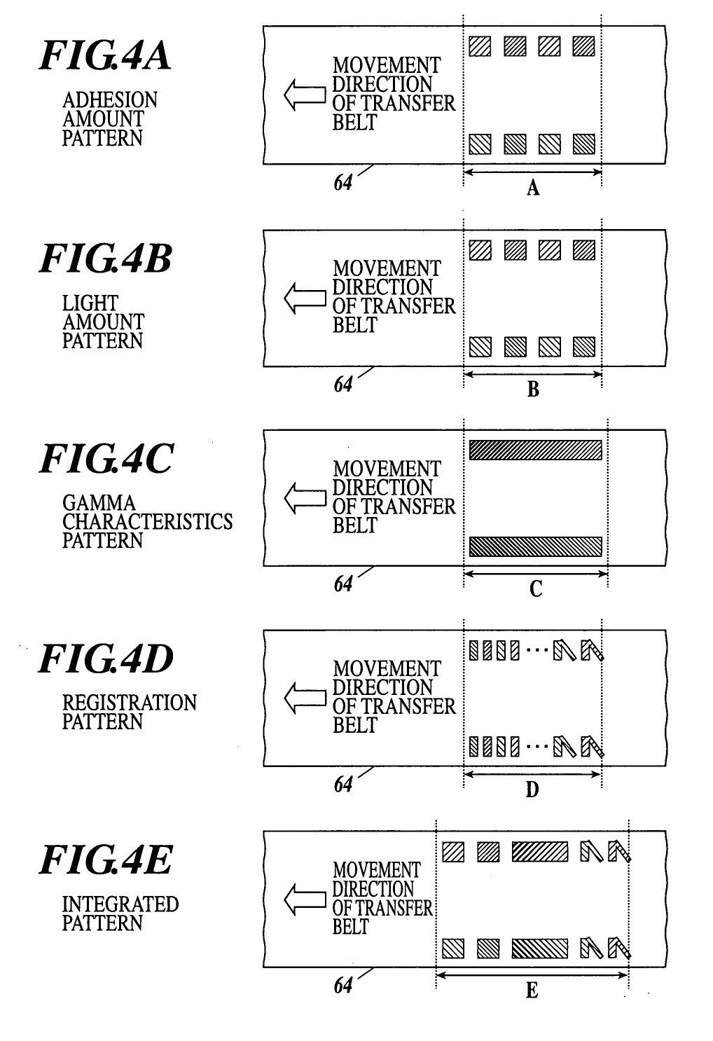

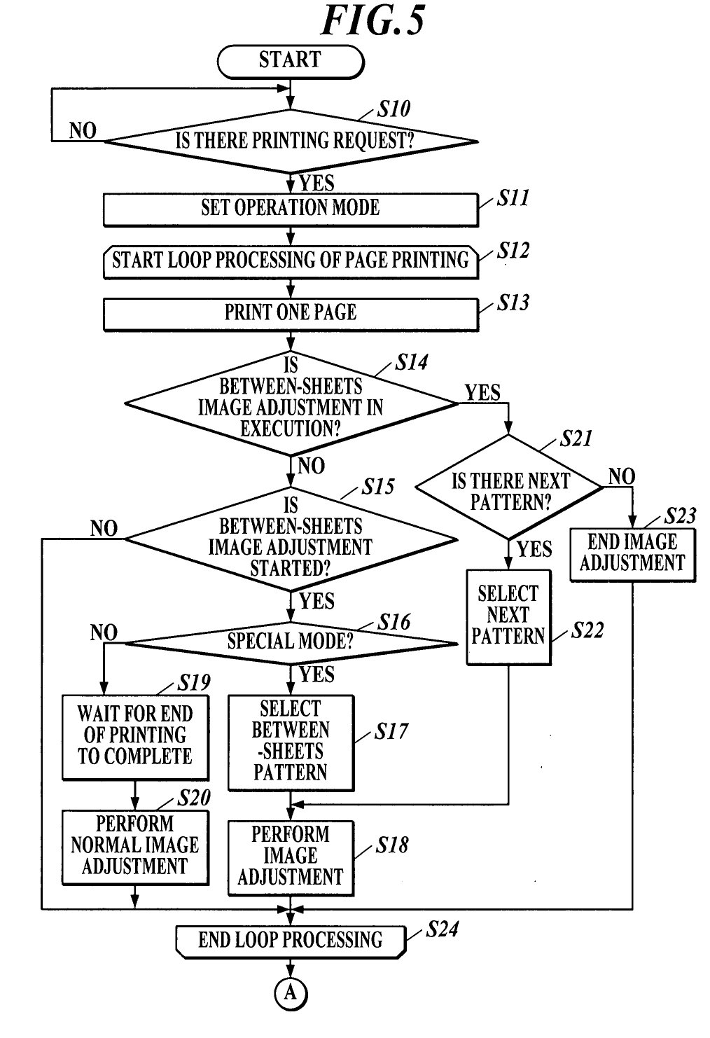

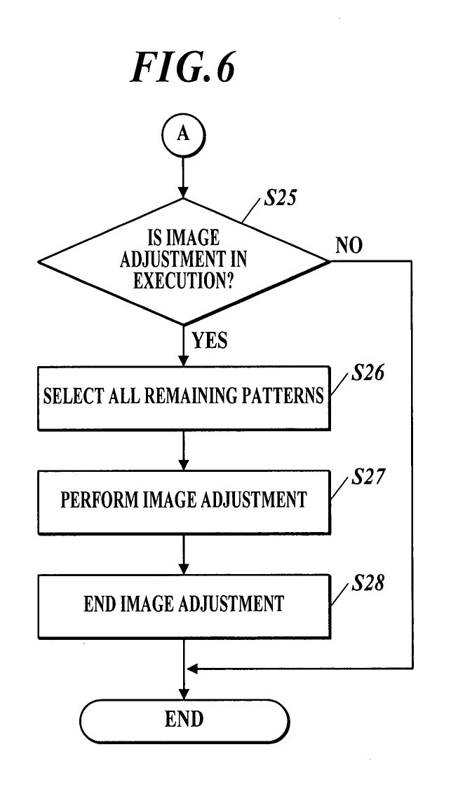

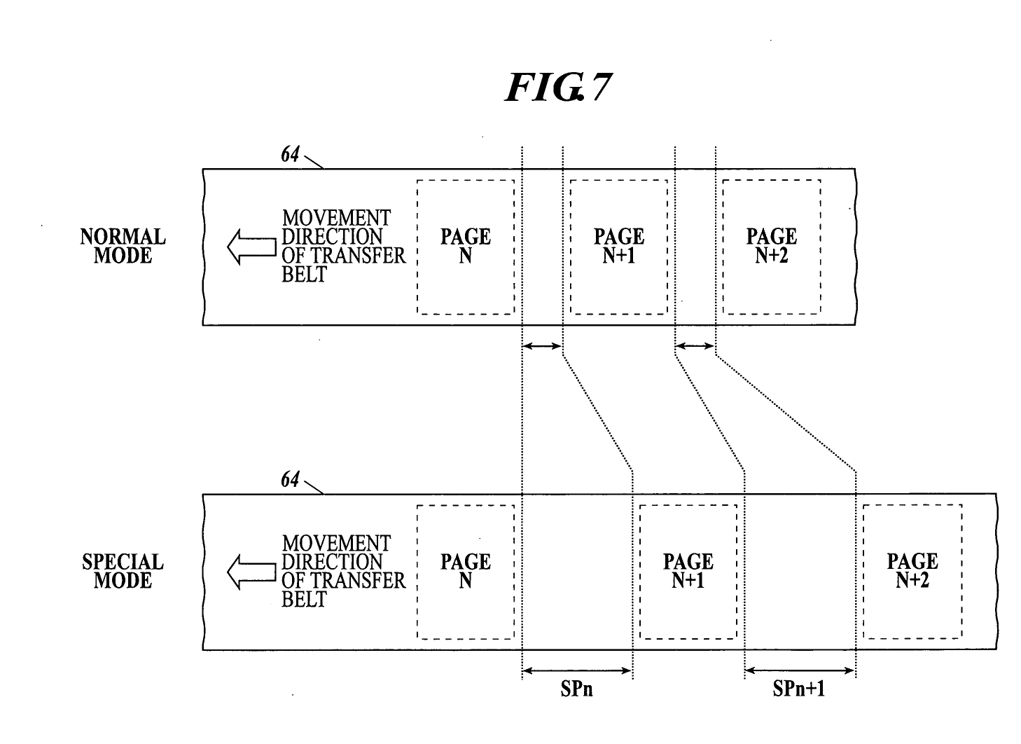

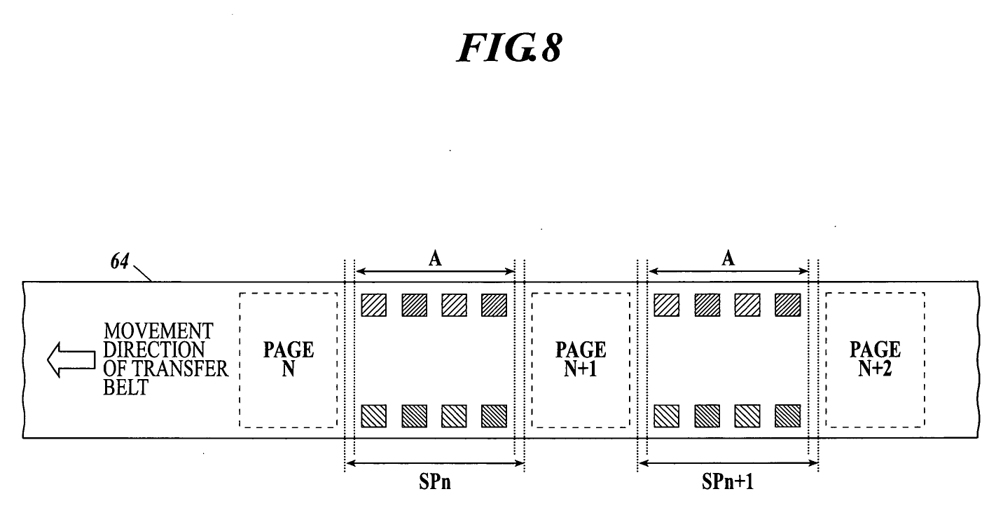

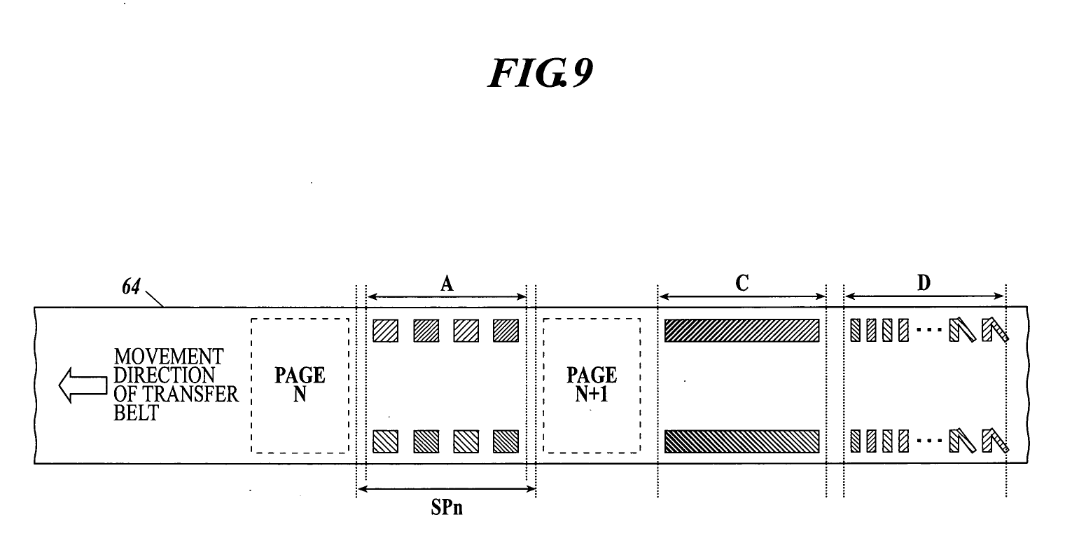

FIG. 1 schematically shows a functional configuration of an image forming apparatus 100. FIG. 2 schematically shows configurations of a conveying section 50, an image forming section 60, and a fusing section 70. FIG. 3 schematically shows contents of image forming instruction information X1. FIG. 4A schematically shows pattern images on an intermediate transfer belt 64 for an adhesion amount adjustment. FIG. 4B schematically shows pattern images on the intermediate transfer belt 64 for a light amount adjustment. FIG. 4C schematically shows pattern images on the intermediate transfer belt 64 for a gamma characteristics adjustment. FIG. 4D schematically shows pattern images on the intermediate transfer belt 64 for a registration adjustment. FIG. 4E schematically shows pattern images on the intermediate transfer belt 64 for adjusting an image integrally. FIG. 5 and FIG. 6 show an operation of the image forming apparatus 100. FIG. 7 shows an example of regions between toner images on the intermediate transfer belt 64 in a successive printing. FIG. 8 shows an example of forming pattern images in the regions between the toner images on the intermediate transfer belt 64 in the successive printing. FIG. 9 shows an example of forming pattern images on the intermediate transfer belt 64 after the successive printing ends.

The configuration of the image forming apparatus 100 such as a printer, a FAX, etc. will be described. As shown in FIG. 1, the image forming apparatus 100 includes a control section 10, an operating section 20, a display section 30, a memory section 40, the conveying section 50, the image forming section 60, the fusing section 70, and a communication section 80, and the above sections are communicably connected to one another by a bus 90. The image forming apparatus 100 may be an MFP (Multi Function Peripheral) which has an image reading section (not shown), etc., for reading an original document image, and provides various functions other than a printer such as a copier, a scanner, etc.

The control section 10 includes a CPU (Central Processing Unit), a ROM (Read Only Memory), a RAM (Random Access Memory), etc. The control section 10 controls operations of the sections to centrally control the entire apparatus by allowing the CPU to develop to a work area of the RAM various control programs and various data stored in the ROM and the memory section 40 and sequentially execute them.

Specifically, the control section 10 performs an image forming in the image forming section 60 by controlling the sections of the apparatus based on a print instruction input through the communication section 80 from another information apparatus or a print instruction input on the operating section 20. In such image forming, the control section 10 performs the image forming in which intervals of conveying recording media and timing of operations in the conveying section 50, the image forming section 60, and the fusing section 70 are adjusted based on an operation mode set by an instruction by the operating section 20 or the communication section 80. Specifically, the control section 10 performs the image forming in the operation mode suitable for a particular type of recording media such as thin sheet, cardboard, OHP (Over Head Projector) sheet, etc. For example, in the operation modes for cardboard, OHP sheet, etc., the control section 10 controls the interval of conveying the recording media longer in successive printing than in normal to allow the fusing section 70 to be heated sufficiently.

The control section 10 reads and sequentially executes the programs and data for the image adjustment stored in the memory section 40, etc. so as to control an image adjustment to be formed on the recording media in the image forming section 60 by the processing described below. The image adjustment performed by the control section 10 starts based on a temperature change around the apparatus measured by a temperature sensor (not shown), elapsed time since the last adjustment measured by a timer (not shown), or the number of sheets of the images formed by the image forming section 60.

The operating section 20 is a panel of operation keys, a pressure sensitive type (resistive film type) touch panel in which transparent electrodes are positioned in a grid-like pattern on a screen of the display section 30, etc. (not shown), and outputs input operation as signals to the control section 10. The operating section 20 is an LCD (Liquid Crystal Display), etc., and displays an image based on displaying control by the control section 10. A user can set the above-described operation mode for the type of recording media by operating the operating section 20. The operation mode may be set by referring to sheet type information set and registered in advance in the memory section 40, etc. for each sheet feeding tray when a sheet feeding tray (not shown) of the conveying section 50 is specified.

The memory section 40 comprises a nonvolatile memory and the like such as a magnetic storage medium, an optical storage medium, a semiconductor, etc., is readable and writable by the control section 10, and stores programs and data for the image adjustment performed in the image forming section 60, various control programs for the entire apparatus, setting information of the apparatus, data input by the communication section 80, etc.

The memory section 40 may employ an interface for attaching a removable storage medium such as the above-described magnetic storage medium, optical storage medium, semiconductor memory, etc., and data may be read and written through the interface. In such a case, under control of the control section 10, data stored in advance in the attached storage medium may be read to execute various operations, image forming in the image forming section 60, data transfer to an external apparatus through the communication section 80, etc.

The conveying section 50 includes a sheet feeding tray, a sheet ejection tray, etc. (not shown) and a conveying mechanism which is described later. Under control of the control section 10, the conveying section 50 successively conveys the recording media stored in the sheet feeding tray to the image forming section 60 and ejects the recording media with the images formed in the image forming section 60 to the sheet ejection tray.

The image forming section 60 is a functional section which forms the color images on the recording media by a method referred to as electrophotography. In the image forming section 60, toner of each color is adhered onto electrostatic latent images formed on photoreceptor drums to form toner images. These toner images are transferred onto the intermediate transfer belt so that the images of each color overlap on one another. The overlapped images are transferred onto the recording media conveyed from the conveying section 50 to form color images. The fusing section 70 is a functional section to perform heat fusing processing by which the toner images formed on the recording media is fixed onto the recording media.

The communication section 80 includes a communication circuit to communicate with other information apparatuses and a communication interface to access to a network which other information apparatuses access to (all of these elements are not shown), and under control of the control section 10, performs data communication.

Next, specific configurations of the conveying section 50, the image forming section 60, and the fusing section 70 will be described. As shown in FIG. 2, the conveying section 50 comprises various rollers such as loop rollers 51, registration rollers 52, transfer rollers 53, first reversal rollers 54, second reversal rollers 55, etc.

The conveying section 50 successively conveys the recording media fed by the sheet feeding tray (not shown) with the above mentioned loop rollers 51, the registration rollers 52, the transfer rollers 53, etc., supplies the recording media to the image forming section 60, and outputs the recording media to which an image have been formed and fixed by the fusing section 70 to the sheet ejection tray, etc. The loop rollers 51 convey the recording media conveyed from the sheet feeding tray or the later-described second reversal rollers 55 toward the image forming section 60. The registration rollers 52 adjust the timing of conveying the recording media conveyed from the loop rollers 51 to the image forming section 60.

In double-sided printing, the conveying section 50 guides the recording media at a downstream side of the fusing section 70 to a different direction from the sheet ejection tray, reverses the front and back sides of the recording media with the first reversal rollers 54 and the second reversal rollers 55, and supplies the recording media to the image forming section 60 again. A roller cleaner 56 abuts on the registration rollers 52 to clean the rollers.

On an upper side of the transfer rollers 53, the image forming section 60 is provided. To the image forming section 60, charging electrodes 62, development sections 63, etc., are provided. In this embodiment four units of rotatable photoreceptor drums 61 are provided with respect to respective color toners, of yellow (Y), magenta (M), cyan (C), and black (K). Around each of the photoreceptor drums 61 are also provided an optical writing section (not shown) comprising an LED (Light Emitting Diode) array head or an LD (Laser Diode) unit, a cleaning section (not shown), etc.

The charging electrodes 62 cause corona discharge on surfaces of the photoconductive drums 61 to equally charge the surfaces of the photoconductive drums 61. The development sections 63 form toner images by adhering the toners charged to have the same polarity as the photoconductive drums 61 to the electrostatic latent images formed on the surfaces of the photoconductive drums 61 by the optical writing sections.

The toner images adhered onto the surfaces of the photoconductive drums 61 are transferred to the intermediate transfer belt 64 provided so as to touch the four units of the photoconductive drums 61. The intermediate transfer belt 64 is inserted between the transfer rollers 53 with the recording media and the toner images on the intermediate transfer belt 64 are transferred onto the recording media by pressing force of the transfer rollers 53.

A cleaning belt 65 abuts on the intermediate transfer belt 64 to remove excess toner remaining on the intermediate transfer belt 64.

The sensor 66 is an optical sensor and the like to measure condition of the toner images adhered on the intermediate transfer belt 64, and detects amount, adhered location, etc. of the toner of each color adhered on the intermediate transfer belt 64 to output them to the control section 10. The control section 10 adjusts the toner amount and the toner image location adhered on the intermediate transfer belt 64 based on the result detected by the sensor 66.

Consequently, the image forming apparatus 100 can adjust to a certain level the variations of thin line reproducibility and white patch reproducibility caused by variations of photoreceptor electrostatic characteristics (charging characteristics and light exposure sensitivity characteristics), image development characteristics (efficiency and edge reinforcement), and transfer characteristics (accuracy and efficiency).

A fusing section 70 is provided on the downstream side of the conveying direction of the transfer rollers 53. In the fusing section 70, a heating roller 71 to heat recording media and a pressure roller 72 to press the recording media are provided to function as fusing rollers. The recording media adhered with the toner images on their surfaces in the image forming section 60 is conveyed to a nip section between the heating roller 71 and the pressure roller 72. The toner melted by heat of the heating roller 71 is fixed to the recording media, and the toner images are fused onto the recording media by the heating roller 71 and pressing force of the pressure roller 72. A cleaning roller 73 abuts on the heating roller 71 for cleaning the surface of the heating roller 71.

In the fusing section 70, a great amount of heat is lost in the toner fusing on the recording media such as cardboard, OHP sheet, etc., compared to normal sheets. Thus, until the fusing section 70 is heated sufficiently after the image is formed on the recording media, the control section 10 controls the conveying section 50 and the image forming section 60 based on the above described operation mode to pause image forming processing onto the recording media, so as to delay the conveying interval of recording media.

The image forming onto the recording media in the conveying section 50, the image forming section 60, and the fusing section 70 and the image adjustment of the image forming section 60 are controlled based on control commands from the control section 10.

As shown in FIG. 3, image forming instruction information X1 includes a management number X11, an image data storage address X12, a printing pattern type X13, an image adjustment pattern type X14, etc.

The management number X11 is an identification number to manage a page number to be printed, image adjustment, etc. The image data storage address X12 is address information to access to the memory section 40 or the ROM in the control section 10 in order to obtain image data indicated by the management number X11. The printing pattern type X13 indicates a forming of a “normal printing pattern” for normal printing onto recording media or an “image adjustment pattern” for performing the image adjustment on the intermediate transfer belt 64.

The image adjustment pattern type X14 takes effect when the printing pattern type X13 indicates the forming of the “image adjustment pattern”, and the image adjustment pattern type X14 indicates a type of toner image for image adjustment to be formed on the intermediate transfer belt 64. Specifically, the image adjustment pattern type X14 indicates “adhesion amount pattern”, “light amount pattern”, “gamma characteristics pattern”, “registration pattern”, “integrated pattern”, or the like.

Here, the image adjustment pattern to be formed on the intermediate transfer belt 64 based on the above control command, etc. will be described. As shown in FIG. 4, the image adjustment patterns include the “adhesion amount pattern”, the “light amount pattern”, the “gamma characteristics pattern”, the “registration pattern” and the “integrated pattern”. Data for forming each pattern is stored in advance in the memory section 40, etc. as readable image data with specified address.

The image data of the image adjustment patterns stored in the memory section 40 may be single piece of image data which includes information about all of the various above described patterns. In such a case, the reading address of the image data may be adjusted as described above to enable acquisition of a pattern image which is a division of a certain pattern of the various patterns. However, the form of the image data is not limited thereto and a piece of image data may be provided for each type of the image adjustment patterns. In such form also, the reading address of the image data may be adjusted to enable acquisition of a pattern image which is a division of each pattern. Further, the image data stored in the memory section 40 may be a plurality of pieces of data respectively for pattern images where the image adjustment patterns are each divided in advance in a predetermined image width. The divided pattern image can be acquired by sequentially reading these image data.

As shown in FIG. 4A, the adhesion amount patterns are patterns formed by forming pattern images of the same shape of the colors of yellow (Y), magenta (M), cyan (C), black (K) while changing a developing bias. The control section 10 allows the sensor 66 to read these patterns, so as to determine the appropriate developing bias.

As shown in FIG. 4B, the light amount patterns are formed by forming pattern images of the same shape of the colors of yellow (Y), magenta (M), cyan (C), black (K) while changing an LED light amount. The control section 10 allows the sensor 66 to read these patterns, so as to determine the appropriate LED light amount for forming an electrostatic latent image.

As shown in FIG. 4C, the gamma characteristics patterns are gamma patterns of the same shape where tones vary. The control section 10 allows the sensor 66 to read these patterns so as to correct a tone correction table, which is referred to in the image forming, to an appropriate value based on the values read.

As shown in FIG. 4D, the registration patterns are for correcting the color shift of colors, and are formed by forming various patterns of the same shape while setting a main scanning, a sub scanning, and an operational frequency (video frequency) of the LED of the development section 63 to a specific value. In the control section 10, the sensor 66 reads these patterns to correct the main scanning, the sub scanning and the video frequency to an appropriate value.

As shown in FIG. 4E, the integrated pattern is formed with all of the above described patterns which are the adhesion amount pattern, the light amount pattern, the gamma characteristics pattern, and the registration pattern. The control section 10 allows the sensor 66 to read these patterns and performs a comprehensive image adjustment. This integrated pattern may not be pattern for adjusting entire ranges of the developing bias, the light amount, the tone correction, etc. to be adjusted, but be a pattern to adjust a certain value of the given values (threshold value, etc.), where each of the above described patterns are simplified.

Next, an operation of the image forming apparatus 100 controlled by the control section 10 will be described in detail. As shown in FIG. 5, the control section 10 determines whether or not there is a printing instruction from the operating section 20 or the communication section 80 (step S10). When there is a printing instruction, the control section 10 sets an operation mode based on the printing instruction from the operating section 20 or the communication section 80 (step S11). When there is no printing instruction, the control section 10 stays on standby in an idle status. While in the idle status, if the image adjustment is performed due to temperature change or a passage of a predetermined span of time, the control section 10 performs conventional image adjustment processing.

When there is a printing instruction, based on the printing instruction, the control section 10 sets the address of data of the image to be formed stored in the memory section 40 and the like, a flag which indicates normal printing, etc., in the management number X11 and the image data storage address X12, and starts a page printing shown in steps S12 to S24. When there is an instruction of printing a plurality of pages, this page printing loop processing is repeated with respect to each page until all pages are printed.

In the page printing, the control section 10 allows the image forming section 60 to print one page based on the printing instruction (step S13), and determines whether or not the image adjustment is in execution(step S14). When the image adjustment is not in execution, the control section 10 determines whether or not to start the image adjustment based on the number of pages printed, etc., (step S15). When it is determined the image adjustment does not start, the process advances to the loop processing of printing a next page.

When it is determined the image adjustment is to start, the control section 10 determines whether or not the operation mode is in a “special mode” which delays the conveying interval of the recording media to the image forming section 60, etc. to perform printing on the above described sheet type such as cardboard, OHP sheet, etc. (step S16).

In step S16, when the mode is in the “special mode”, the control section 10 selects any one or more of the “adhesion amount pattern”, the “light amount pattern”, the “gamma characteristics pattern”, the “registration pattern” or the “integrated pattern” and further selects one pattern from the above selected patterns to be formed in a region between the toner images (between the sheets) on the intermediate transfer belt 64 under the successive page printing (step S17). Then, the control section 10 outputs a printing command to the image forming section 60 to form the selected pattern between the toner images in the page printing, and performs the image adjustment based on the value detected by the sensor 66 (step S18). The pattern in step S17 may be set according to characteristics that is to be adjusted, and may be any one pattern such as only the “adhesion amount pattern”, setting a plurality of patterns, or all of the patterns.

When the operation mode is not in the “special mode” in step S16, in other words, when the successive printing is performed on normal sheets, etc., where the region between the toner images on the intermediate transfer belt 64 is too small to form the image adjustment pattern since there is no need to delay the conveying interval, the control section 10 checks whether or not the image forming by the one page printing in the image forming section 60 in step S13 has ended, and waits for the printing processing to end completely (step S19) and thereafter performs a normal image adjustment (step S20).

In step S14, when the image adjustment is in execution, in other words, when the image adjustment has been started in step S15 of the previous loop, the control section 10 determines if there is any “next pattern” which has not been selected to be output for the image adjustment among the patterns set in step S17 (step S21). When there is “next pattern”, the control section 10 selects one image adjustment pattern from the “next pattern”, advances the process to step S18 and performs the image adjustment. Alternatively, when there is no “next pattern”, in other words, when the image adjustment has been performed using all image adjustment patterns set in step S17 or when the normal image adjustment has been performed, the control section 10 ends the image adjustment (step S23).

As shown in FIG. 6, after the page printing of the above steps S12 to S24 ends, in other words, after all pages are printed, the control section 10 determines whether or not the image adjustment is in execution as in step S14 (step S25), and when the image adjustment is not in execution, ends the processing. When the image adjustment is in execution, the control section 10 selects the remaining image adjustment pattern which has not been selected to be output for the image adjustment (step S26), outputs the printing command to form the remaining image adjustment pattern to the image forming section 60, performs the image adjustment based on the value detected by the sensor 66 (step S27), and ends the image adjustment (step S28).

As described above, the image forming apparatus 100 performs the successive page printing under control of the control section 10. In the successive page printing, the registration rollers 52 adjust conveying of the recording media to the image forming section 60 based on the operation mode, and as shown in FIG. 7, between-image regions SPn, SPn+1, are formed between the toner images of the page printing on the intermediate transfer belt 64. The between-image regions SPn, SPn+1 are larger in the special mode, in which the recording media such as cardboard and the like are printed, because the conveying interval is delayed as described above.

The image forming apparatus 100, by executing the page printing of the above described steps S12 to S24 when set to the special mode, can perform the image adjustment by forming divided adhesion amount pattern A and divided light amount pattern B in the between-image regions SPn to SPn+1 of the pages N to N+2 as shown in FIG. 8. As well as the example in FIG. 8, the image adjustment may be performed by forming any of the patterns of the “gamma characteristics pattern”, the “registration pattern” or the “integrated pattern”.

As shown in FIG. 9, even when the image adjustment of forming the light amount pattern B in the between-image region SPn is performed and the printing ends at the page N+1 before all of the image adjustment patterns are formed to perform the image adjustment, the image forming apparatus 100 can form the rest of the image adjustment patterns (for example, divided gamma characteristics pattern C, divided registration pattern D, etc.) to perform the image adjustment by executing the steps S25 to S28 after the page printing ends.

As described above, under control of the control section 10, the image forming apparatus 100 forms the image adjustment pattern in the region between the toner images on the intermediate transfer belt 64 of the image forming section 60, detects the pattern with the sensor 66 and adjusts the images, so that the image adjustment is performed during the successive printing in the image forming section 60 based on the operation mode set on the operating section 20 or through the communication section 80.

Consequently, when the successive printing of color images is performed onto recording media such as cardboard, etc., the image forming apparatus 100 can perform the image adjustment by forming the image adjustment pattern on the intermediate transfer belt in the region between the toner images which is larger than normal due to the operation mode for printing cardboard, etc., without providing additional sensors to perform the image adjustment more efficiently. Therefore, the image forming apparatus 100 can perform the image adjustment of the color images to be formed without interrupting the operation of the successive printing, in other words, without reducing the printing speed.

That is, when the successive printing of color images is performed on recording media such as cardboard, etc., the image forming apparatus 100 can perform the image adjustment without increasing the production cost of the apparatus or reducing the printing speed.

When the image adjustment is performed with a plurality of image adjustment patterns in the successive printing, the image forming apparatus 100 successively forms the image adjustment patterns in a plurality of regions between the toner images during the successive printing. Even when there are a plurality of image adjustment patterns and the image adjustment patterns do not fit into one region between the toner images, the image forming apparatus 100 can perform the image adjustment without interrupting the successive printing.

After the successive printing ends, the image forming apparatus 100 performs the image adjustment by forming the image adjustment pattern remaining from the image adjustment patterns successively formed in the plurality of regions between the toner images. Consequently, even when the successive printing ends while image adjustment during the successive printing is in execution, the image forming apparatus 100 can reliably perform the entire image adjustment.

The image forming apparatus 100 performs the image adjustment by forming one or more of image adjustment patterns which are the “adhesion amount pattern”, the “light amount pattern”, the “gamma characteristics pattern”, the “registration pattern”, and. the “integrated pattern” during the successive printing in the image forming section 60. Consequently, the image forming apparatus 100 can promptly adjust the toner adhesion amount, the image light amount, the gamma characteristics, the color shift, etc., or perform an overall image adjustment, during the successive printing.

The image forming apparatus 100 receives a direct instruction on the operating section 20 by a user or an instruction on the communication section 80 through communication so as to set the operation mode of the conveying section 50, the image forming section 60, and the fusing section 70. Consequently, the image forming apparatus 100 can perform the image adjustment during the successive printing in the operation mode based on the user's operation. Also, when the image forming apparatus 100 receives an instruction from a user about a sheet type, etc., the image forming apparatus 100 can set the operation mode according to the type of recording media by referring to the sheet type information stored in the memory section 40.

The descriptions of the embodiments are to show an example of the present invention, and thus are not intended to limit the present invention. The configuration and the operation of the embodiment may be modified without departing from the scope of the invention

For example, in the image forming apparatus 100, when the image adjustment is performed in the successive printing, one image adjustment pattern is selected and set to be formed in each region between the toner images. Alternatively, if the image adjustment pattern is small enough compared to the region between the toner images so that a plurality of image adjustment patterns fit in one region, the plurality of image adjustment patterns may be selected.

What is claimed is:

1. An image forming apparatus comprising:
a setting section to set an operation mode in image forming;
a conveying section to successively convey recording media for the image forming at an interval based on the set operation mode;
an image forming section to form color images by forming toner images in which color toners are adhered on an intermediate transfer belt and transferring the toner images onto the conveyed recording media respectively;
a memory section to store image data of an image adjustment pattern image used in an adjustment of the color image formed in the image forming section; and
a control section to perform the image adjustment in a successive printing in which the images are successively formed on the recording media in the image forming section, the image adjustment performed by forming an image adjustment toner image based on the image data stored in the memory section in a region between the toner images of the successive printing formed on the intermediate transfer belt according to the set operation mode.

2. The image forming apparatus of claim 1, wherein when the image adjustment of the successive printing is performed by forming a plurality of the image adjustment toner images, the control section allows the image forming section to successively form the image adjustment toner images in a plurality of regions between the toner images in the successive printing.

3. The image forming apparatus of claim 2, wherein when the successive printing ends while the image adjustment of the successive printing is performed by forming the plurality of the image adjustment toner images, the control section allows the image forming section to form a remaining image of the plurality of the image adjustment toner images, which has not formed in the regions between the toner images.

4. The image forming apparatus of claim 1, wherein the image data of the image adjustment pattern image stored in the memory section is image data of an adhesion amount adjustment pattern image to adjust toner amount adhered on the recording media, and the control section controls an adjustment of the toner amount adhered on the recording media in the image forming section by forming a toner amount adjustment toner image based on the image data in the region between the toner images.

5. The image forming apparatus of claim 1, wherein the image data of the image adjustment pattern image stored in the memory section is image data of light amount adjustment pattern image to adjust light amount for forming the images on the recording media, and the control section controls an adjustment of the light amount for forming the images by the image forming section by forming a light amount adjustment toner image based on the image data in the region between the toner images.

6. The image forming apparatus of claim 1, wherein the image data of the image adjustment pattern image stored in the memory section is image data of gamma value adjustment pattern image to adjust gamma value of the images formed on the recording media, and the control section controls an adjustment of the gamma value of the images formed by the image forming section by forming a gamma value adjustment toner image based on the image data in the region between the toner images.

7. The image forming apparatus of claim 1, wherein the image data of the image adjustment pattern image stored in the memory section is image data of registration pattern image to adjust color shift of colors of the images formed on the recording media, and the control section controls a degree of the color shift of the colors of the images formed by the image forming section by forming a toner adhesion location adjustment toner image of the colors based on the image data in the region between the toner images.

8. The image forming apparatus of claim 1, wherein the image data of the image adjustment pattern image stored in the memory section is image data of an integrated adjustment pattern image to adjust a color shift degree of the colors, a toner adhesion amount, a light amount, and a gamma value of the images formed on the recording media, and the control section controls an adjustment of the images formed on the recording media by the image forming section by forming an image adjustment toner image based on the image data in the region between the toner images.

9. The image forming apparatus of claim 1, wherein the setting section sets the operation mode by receiving an operating instruction from a user.

10. The image forming apparatus of claim 1, wherein the setting section sets the operation mode based on a type of the recording media conveyed by the conveying section.

11. A method of image forming controlled by a control section comprising:
setting an operation mode in image forming;
forming color images by forming toner images in which color toners are adhered on an intermediate transfer belt and transferring the toner images onto the recording media respectively, conveyed according to the set operation mode; and
performing an image adjustment in a successive printing in which the images are successively formed on the recording media in the image forming processing, the image adjustment performed by forming an image adjustment toner image based on image data of image adjustment pattern image used for adjustment of the color images formed in the image forming stored in advance in a memory section in a region between the toner images of the successive printing formed on the intermediate transfer belt according to the set operation mode.

12. The image forming processing of claim 11, wherein in the performing step of the image adjustment, when the image adjustment of the successive printing is performed by forming a plurality of the image adjustment toner images, the image adjustment toner images is successively formed in a plurality of regions between the toner images in the successive printing.

13. The image forming processing of claim 12, wherein in the performing step of the image adjustment, when the successive printing ends while the image adjustment of the successive printing is performed by forming the plurality of the image adjustment toner images, a remaining image of the plurality of the image adjustment toner images, which has not formed in the regions between the toner images is formed.
